(19) United States
(12) Patent Application Publication
(10) Pub. No.: US 2018/0376180 A1
(43) Pub. Date: Dec. 27, 2018

(54) METHOD AND APPARATUS FOR METADATA INSERTION PIPELINE FOR STREAMING MEDIA

(71) Applicant: THOMSON LICENSING, Issy-les-Moulineaux (FR)

(72) Inventor: Satheesh RAMALINGAM, Cupertino, CA (US)

(21) Appl. No.: 16/066,183

(22) PCT Filed: Dec. 29, 2015
(86) PCT No.: PCT/US2015/067896

§ 371 Date: Jun. 26, 2018

(51) Int. Cl. H04N 21/236; G06F 17/30; H04N 21/84; H04N 21/235

(52) U.S. Cl. CPC H04N 21/23614; H04N 21/2355; H04N 21/84; G06F 17/30858

(57) ABSTRACT

High dynamic range (HDR) information that qualifies a standard dynamic range (SDR) stream is inserted as metadata into a media item. Supplemental enhancement information (SEI) network abstract layer (NAL) is used to transmit metadata within advanced video coding (AVC) or high efficiency video coding (HVEC) streams. A media file is received and a video frame index is generated. Elementary streams of tracks are copied to separate files. Metadata information is formatted as a payload of SEI NAL. SEI is inserted using a pipeline model that reads video frames using the video frame index, assigns a frame count based on a display timestamp, generates an index list of NALs inside a video frame, identifies a metadata payload suitable for a given display frame number and NAL type, inserts SEI metadata as a node in the NAL index list, and generates a video elementary stream using the NAL index list.

### BACKGROUND

Media files include video elementary streams multiplexed with other media tracks. Inserting metadata (having a size of a few bytes) inside video elementary stream within the media file is a memory and CPU intensive task.

Existing solutions locate video frame markers within a container using deep packet inspection (i.e., parsing all bytes of media file), insert metadata bytes within the media file using memory moves, and/or perform partial decoding of AVC/HEVC streams to identify display frame count.

Therefore, there exists a need for a solution that does not require parsing all bytes of a media file or requiring memory moves.

### SUMMARY

High dynamic range (HDR) information that qualifies a standard dynamic range (SDR) stream may be inserted as metadata into a media item. Supplemental enhancement information (SEI) network abstract layer (NAL) may be used to transmit metadata within advanced video coding (AVC) or high efficiency video coding (HVEC) streams.

Some embodiments receive a media file and generate a video frame index. The index may include, for instance, byte offset, size, and time stamps. The index may be generated using tools associated with container standards (e.g., motion picture experts group transport stream (MPEG TS), MPEG-4 Part-14 (MP4), etc.) without requiring deep packet inspection.

In addition, elementary streams of tracks may be copied to separate files by some embodiments. Such elementary streams may be available to be merged with a modified video stream with inserted metadata.

Metadata information may be formatted as a payload of SEI NAL. SEI may be inserted using a pipeline model.

A first stage of the pipeline model includes reading video frames using the video frame index generated earlier. A second stage includes assigning a frame count based on a display timestamp. A third stage includes generating an index list of NALs inside a video frame. The index may include, for instance, byte offset, size, NAL type, etc. The index may be generated by reading a portion of a video frame (e.g., a first few hundred bytes). A fourth stage includes identifying a metadata payload suitable for a given display frame number and NAL type and inserting SEI metadata as a node in the NAL index list. A fifth stage includes generating a video elementary stream using the NAL index list. The media file is recreated by multiplexing the video elementary stream having inserted metadata with the other elementary stream tracks.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a metadata insertion system according to an exemplary embodiment;

FIG. 2 illustrates a flow chart of an exemplary process that inserts metadata into a media item;

FIG. 3 illustrates a flow chart of an exemplary process that implements a pipeline model of metadata insertion; and

FIG. 4 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to insert metadata into media content using a pipeline approach.

A first exemplary embodiment provides a method that associates metadata with a media content item. The method includes retrieving an input media content item, generating a video frame index based at least partly on header information associated with the media content item; extracting a set of elementary streams from the input media content item, formatting metadata for insertion into at least one elementary stream, inserting the metadata into the at least one elementary stream, and generating an output media content item by multiplexing the at least one elementary streams with other elementary streams from the set of elementary streams.

A second exemplary embodiment provides a non-transitory computer useable medium having stored thereon instruction that cause one or more processors to collectively retrieve an input media content item, generate a video frame index based at least partly on header information associated with the media content item, extract a set of elementary streams from the input media content item, format metadata for insertion into at least one elementary stream; insert the metadata into the at least one elementary stream, and generate an output media content item by multiplexing the at least one elementary streams with other elementary streams from the set of elementary streams.

A third exemplary embodiment provides a server that associates metadata with a media content item. The server includes a processor for executing sets of instructions and a non-transitory medium that stores the sets of instructions. The sets of instructions include retrieving an input media content item; generating a video frame index based at least partly on header information associated with the media content item, extracting a set of elementary streams from the input media content item, formatting metadata for insertion into at least one elementary stream; inserting the metadata into the at least one elementary stream, and generating an output media content item by multiplexing the at least one elementary streams with other elementary streams from the set of elementary streams.

Several more detailed embodiments are described in the sections below. Section I provides a description of a system architecture used by some embodiments. Section II then describes various methods of operation used by some embodiments. Lastly, Section III describes a computer system that implements some of the embodiments.

### I. System Architecture

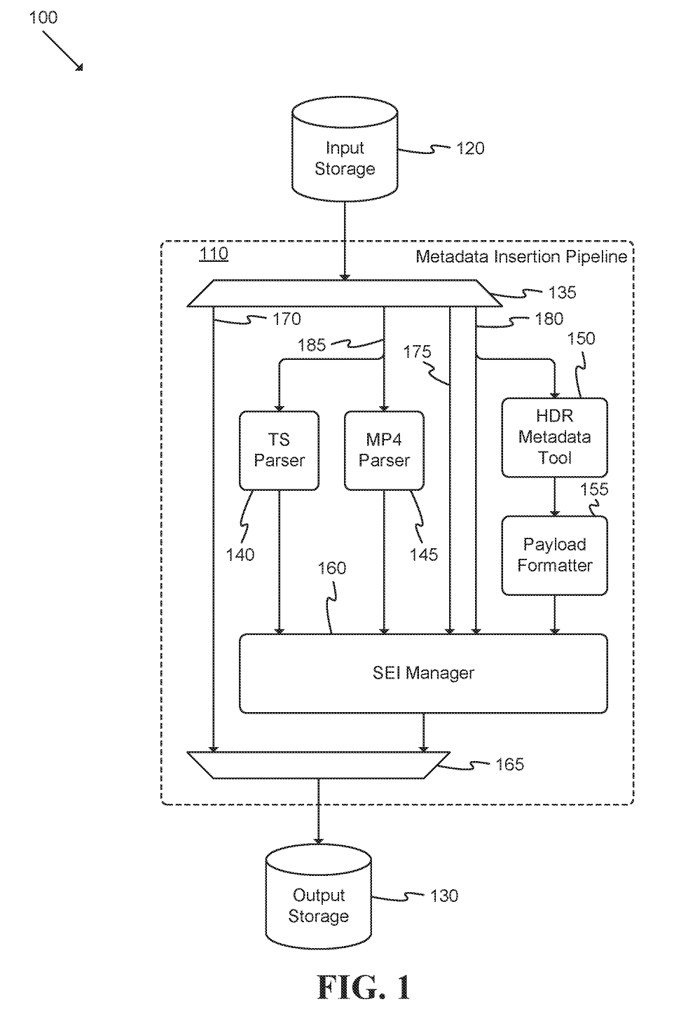

FIG. 1 illustrates a schematic block diagram of a metadata insertion system 100 according to an exemplary embodiment. As shown, the system may include a metadata insertion pipeline 110, an input storage 120, and an output storage 130. The pipeline 110 may include a demultiplexer 135, a set of parsers 140, 145, a metadata tool 150, a payload formatter 155, an SEI manager 160, and a multiplexer 165.

The pipeline 110 may include one or more electronic devices. Such devices may include, for instance, servers, storages, video processors, etc.

The input storage 120 and output storage 130 may be sets of electronic devices capable of storing media files. The storages may be associated with various other elements, such as servers, that may allow the storages to be accessed by the pipeline 110. In some embodiments, the storages 120, 130 may accessible via a resource such as an application programming interface (API). The storages may be accessed locally (e.g., using a wired connection, via a local network connection, etc.) and/or via a number of different resources (e.g., wireless networks, distributed networks, the Internet, cellular networks, etc.).

The demultiplexer 135 may be able to identify and separate track data related to a media item. Such track data may include, for instance, audio and other track elementary streams 170, video frame index information 175, a video elementary stream 180, and/or other appropriate tracks or outputs 185.

The MPEG2 Transport Stream parser 140 may be able to extract timestamp information from the media item. The MP4 parser 145 may be able to extract Moving Picture Experts Group (MPEG) 4 Part-14 information from the media item. Different embodiments may include different parsers (e.g., parsers associated with other media file types).

The high dynamic range (HDR) metadata tool 150 may be able to generate metadata based at least partly on the video elementary stream 180. The payload formatter 155 may be able to generate SEI payload information using the metadata generated by tool 150. SEI messages may include tone-mapping curves that map higher bit depth content to a lower number of bits.

The SEI manager 160 may be able to create and insert SEI messages into the video stream based on the video frame index information 175, received from parsers 140 to 145, video elementary stream 180, and payloads received from the formatter 155.

Multiplexer 165 may combine the modified video stream received from the SEI manager 160 and any other tracks 170 to generate an output media item with embedded metadata.

One of ordinary skill in the art will recognize that system 100 may be implemented in various different ways without departing from the scope of the disclosure. For instance, various elements may be omitted and/or other elements may be included. As another example, multiple elements may be combined into a single element and/or a single element may be divided into multiple sub-elements. Furthermore, the various elements may be arranged in various different ways with various different communication pathways.

### II. Methods of Operation

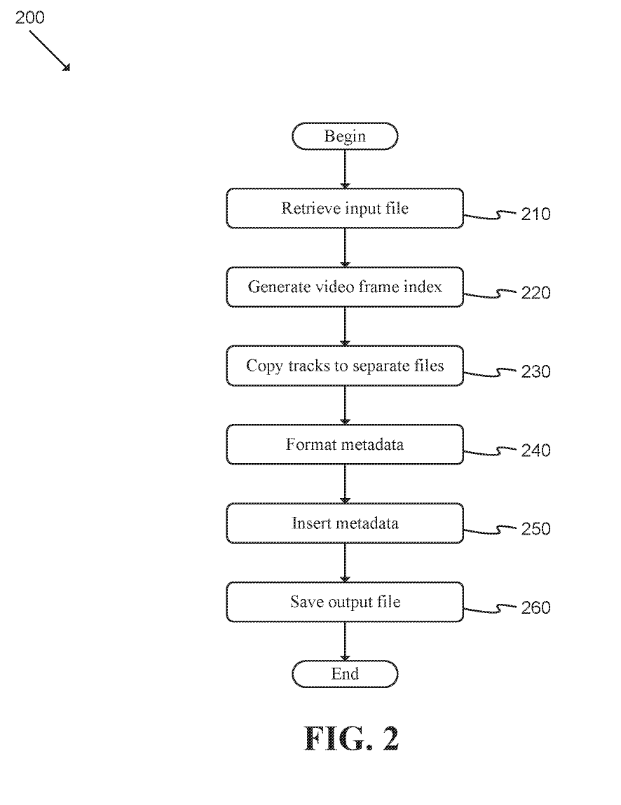

FIG. 2 illustrates a flow chart of an exemplary process 200 that inserts metadata into a media item. Such a process may be implemented by a system such as system 100 described above. The process may begin, for instance, when a media item is available for processing.

As shown, the process may retrieve (at 210) an input file. Such a file may be a media content item that uses an AVC/HVEC stream.

Next, process 200 may generate (at 220) a video frame index. The process may identify video frame boundaries and generate indexes and timestamps for each video frame. Each index may include, for instance, byte offset and size. The timestamps may include presentation timestamps (PTS), decode timestamps (DTS), and/or other appropriate timestamps. The index may be generated using elements such as TS parser 140 and/or MP4 parser 145. Frame boundaries may be identified using a payload unit start indicator (PUSI) flag from the timestamp header, while the packetized elementary stream (PES) header may be used to identify the PTS and DTS. For file types such as MP4, frame boundaries may be calculated from sample table (STBL) box elements such as sample to chunk (STSC), sample table size (STSZ), sample table chunk offset (STCO), and sample table time to sample (STTS). In this way, deep packet inspection is not required for index generation.

The process may then extract and copy (at 230) elementary stream tracks (e.g., video, audio, etc.) to separate files. Such streams may be extracted using a resource such as demultiplexer 135. Next, the process may format (at 240) metadata as a payload of SEI NAL.

The process may then insert (at 250) the metadata into the media item. Such insertion will be described in more detail in reference to process 300 below.

Process 200 may then save (at 260) an output file that includes the inserted metadata and then may end.

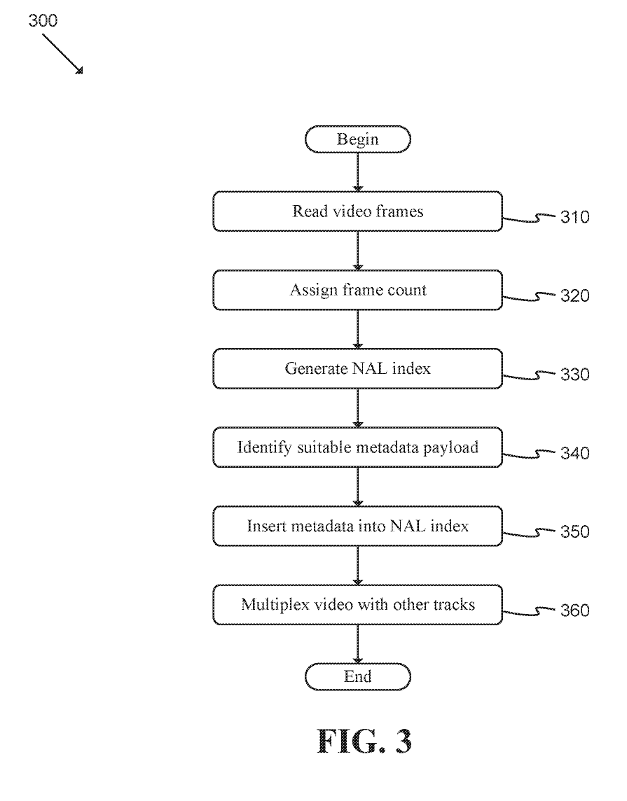

FIG. 3 illustrates a flow chart of an exemplary process 300 that implements a pipeline model of metadata insertion. Such a process may be implemented by a system such as system 100 described above. The process may begin, for instance, when the video frame index and metadata payloads become available.

As shown, the process may read (at 310) video frames using the video frame index generated previously. Next, the process may assign (at 320) frame count based on PTS information.

Process 300 may then generate (at 330) a NAL index list including, for instance, byte offset, size, and NAL type. The NAL index list may be generated by reading a portion of each video frame (e.g., the first few hundred bytes). PTS and DTS information may be used to determine a display order by calculating decoding frame count and display frame count.

Next, the process may identify (at 340) a suitable metadata payload for each frame. The payload may be identified by a resource such as SEI manager 160 based at least partly on metadata supplied by an element such as payload formatter 155. A suitable payload may be identified based on, for instance, display frame number and NAL type.

The process may then insert (at 350) the identified metadata into the NAL index list. The metadata may be preloaded by reading the SEI payloads and sorting based on frame count. During insertion, the appropriate SEI payloads may be inserted as nodes in the NAL index list by using the preloaded data as a lookup map. Such a scheme does not require memory moves for insertion. The NAL index list may be used to generate the modified elementary stream that includes inserted metadata.

Next, the process may multiplex (at 360) the modified elementary stream video track with other available tracks and then may end.

One of ordinary skill in the art will recognize that processes 200 and 300 may be performed in various different ways without departing from the scope of the disclosure. For instance, each process may include various additional operations and/or omit various operations. The operations may be performed in a different order than shown. In addition, various operations may be performed iteratively and/or performed based on satisfaction of some criteria. Each process may be divided into multiple sub-processes or included as part of a larger macro process.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout the disclosure.

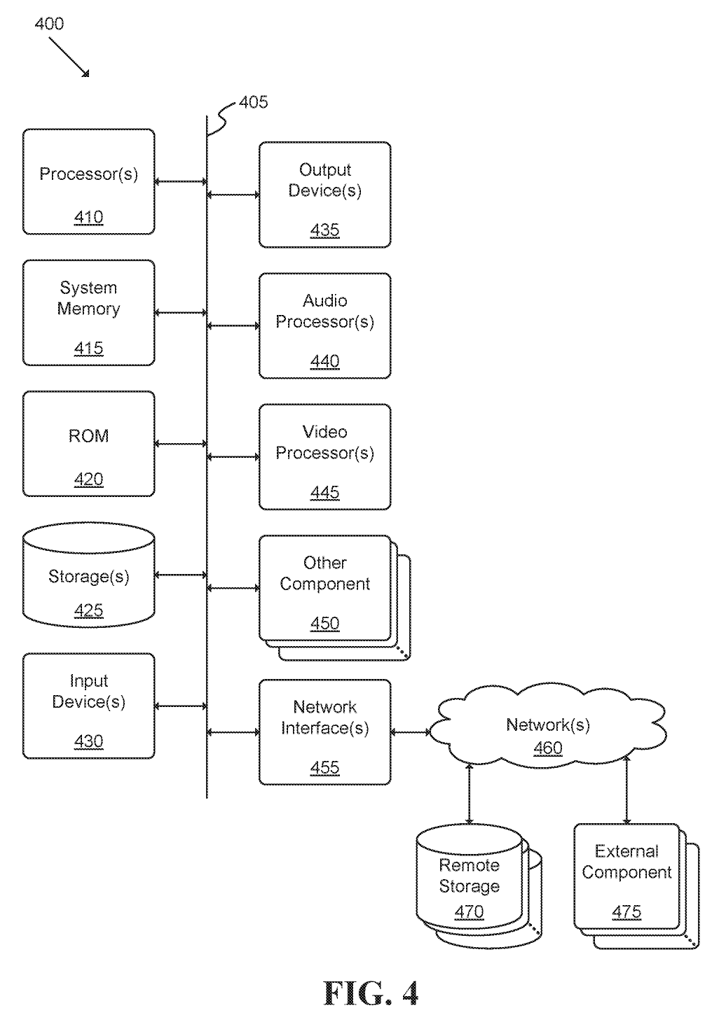

FIG. 4 illustrates a schematic block diagram of an exemplary computer system 400 used to implement some embodiments. For example, the system described above in reference to FIG. 1 may be at least partially implemented using computer system 400. As another example, the processes described in reference to FIGS. 2-3 may be at least partially implemented using sets of instructions that are executed using computer system 400.

Computer system 400 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 400 may include at least one communication bus 405, one or more processors 410, a system memory 415, a read-only memory (ROM) 420, permanent storage devices 425, input devices 430, output devices 435, audio processors 440, video processors 445, various other components 450, and one or more network interfaces 455.

Bus 405 represents all communication pathways among the elements of computer system 400. Such pathways may include wired, wireless, optical, and/or other appropriate communication pathways. For example, input devices 430 and/or output devices 435 may be coupled to the system 400 using a wireless connection protocol or system.

The processor 410 may, in order to execute the processes of some embodiments, retrieve instructions to execute and/or data to process from components such as system memory 415, ROM 420, and permanent storage device 425. Such instructions and data may be passed over bus 405.

System memory 415 may be a volatile read-and-write memory, such as a random access memory (RAM). The system memory may store some of the instructions and data that the processor uses at runtime. The sets of instructions and/or data used to implement some embodiments may be stored in the system memory 415, the permanent storage device 425, and/or the read-only memory 420. ROM 420 may store static data and instructions that may be used by processor 410 and/or other elements of the computer system.

Permanent storage device 425 may be a read-and-write memory device. The permanent storage device may be a non-volatile memory unit that stores instructions and data even when computer system 400 is off or unpowered. Computer system 400 may use a removable storage device and/or a remote storage device as the permanent storage device.

Input devices 430 may enable a user to communicate information to the computer system and/or manipulate various operations of the system. The input devices may include keyboards, cursor control devices, audio input devices and/or video input devices. Output devices 435 may include printers, displays, audio devices, etc. Some or all of the input and/or output devices may be wirelessly or optically connected to the computer system 400.

Audio processor 440 may process and/or generate audio data and/or instructions. The audio processor may be able to receive audio data from an input device 430 such as a microphone. The audio processor 440 may be able to provide audio data to output devices 440 such as a set of speakers. The audio data may include digital information and/or analog signals. The audio processor 440 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 445 (or graphics processing unit) may process and/or generate video data and/or instructions. The video processor may be able to receive video data from an input device 430 such as a camera. The video processor 445 may be able to provide video data to an output device 440 such as a display. The video data may include digital information and/or analog signals. The video processor 445 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 450 may perform various other functions including providing storage, interfacing with external systems or components, etc.

Finally, as shown in FIG. 4, computer system 400 may include one or more network interfaces 455 that are able to connect to one or more networks 460. For example, computer system 400 may be coupled to a web server on the Internet such that a web browser executing on computer system 400 may interact with the web server as a user interacts with an interface that operates in the web browser. Computer system 400 may be able to access one or more remote storages 470 and one or more external components 475 through the network interface 455 and network 460. The network interface(s) 455 may include one or more application programming interfaces (APIs) that may allow the computer system 400 to access remote systems and/or storages and also may allow remote systems and/or storages to access computer system 400 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 400 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method that associates metadata with a media content item, the method comprising:
retrieving an input media content item;
generating a video frame index based at least partly on header information associated with the media content item;
extracting a set of elementary streams from the input media content item;
formatting metadata for insertion into at least one elementary stream;
inserting the metadata into the at least one elementary stream; and
generating an output media content item by multiplexing the at least one elementary streams with other elementary streams from the set of elementary streams.

2. The method of claim 1, wherein inserting the metadata comprises:
reading frames from the video frame index;
assigning, for each frame, a frame count based on a display timestamp associated with the frame;
generating a network abstract layer (NAL) index list by reading a portion of each frame;
identifying a suitable metadata payload based at least partly on display frame number and NAL type; and
inserting the suitable metadata payload as a node in the NAL index list.

3. The method of claim 2, wherein the NAL index list comprises byte offset, size, and NAL type.

4. The method of claim 2, wherein the NAL index list is sorted by display order based on at least one of the display timestamp and a decode timestamp.

5. The method of claim 2, wherein inserting the suitable metadata payload comprises:
preloading the metadata by reading the metadata payloads and sorting based on frame count; and
inserting each node using the preloaded metadata as a lookup map.

6. The method of claim 1, wherein the metadata is formatted as a pay load of supplemental enhancement information associated with a network abstract layer.

7. The method of claim 1, wherein the video frame index comprises byte offset, size, presentation timestamp and decode timestamp information for each video frame.

8. A non-transitory computer useable medium having stored thereon instruction that cause one or more processors to collectively:
retrieve an input media content item;
generate a video frame index based at least partly on header information associated with the media content item;
extract a set of elementary streams from the input media content item;
format metadata for insertion into at least one elementary stream;
insert the metadata into the at least one elementary stream; and
generate an output media content item by multiplexing the at least one elementary streams with other elementary streams from the set of elementary streams.

9. The non-transitory computer useable medium of claim 8, wherein the metadata insertion comprises:
reading frames from the video frame index;
assigning, for each frame, a frame count based on a display timestamp associated with the frame;
generating a network abstract layer (NAL) index list by reading a portion of each frame;
identifying a suitable metadata payload based at least partly on display frame number and NAL type; and
inserting the suitable metadata payload as a node in the NAL index list.

10. The non-transitory computer useable medium of claim 9, wherein the NAL index list comprises byte offset, size, and NAL type.

11. The non-transitory computer useable medium of claim 9, wherein the NAL index list is sorted by display order based on at least one of the display timestamp and a decode timestamp.

12. The non-transitory computer useable medium of claim 9, wherein insertion of the suitable metadata pay load comprises:
preloading the metadata by reading the metadata payloads and sorting based on frame count; and
inserting each node using the preloaded metadata as a lookup map.

13. The non-transitory computer useable medium of claim 8, wherein the metadata is formatted as a payload of supplemental enhancement information associated with a network abstract layer.

14. The non-transitory computer useable medium of claim 8, wherein the video frame index comprises byte offset, size, presentation timestamp and decode timestamp information for each video frame.

15. A server that associates metadata with a media content item, the server comprising:
a processor for executing sets of instructions; and
a non-transitory medium that stores the sets of instructions, wherein the sets of instructions comprise:
retrieving an input media content item;
generating a video frame index based at least partly on header information associated with the media content item;
extracting a set of elementary streams from the input media content item;
formatting metadata for insertion into at least one elementary stream;
inserting the metadata into the at least one elementary stream; and
generating an output media content item by multiplexing the at least one elementary streams with other elementary streams from the set of elementary streams.

16. The server of claim 15, wherein inserting the metadata comprises:
reading frames from the video frame index;
assigning, for each frame, a frame count based on a display timestamp associated with the frame;
generating a network abstract layer (NAL) index list by reading a portion of each frame;
identifying a suitable metadata payload based at least partly on display frame number and NAL type; and
inserting the suitable metadata payload as a node in the NAL index list.

17. The server of claim 16, wherein the NAL index list comprises byte offset, size, and NAL type.

18. The server of claim 16, wherein the NAL index list is sorted by display order based on at least one of the display timestamp and a decode timestamp.

19. The server of claim 16, wherein inserting the suitable metadata payload comprises:
preloading the metadata by reading the metadata payloads and sorting based on frame count; and
inserting each node using the preloaded metadata as a lookup map.

20. The server of claim 15, wherein the metadata is formatted as a payload of supplemental enhancement information associated with a network abstract layer.

21. (canceled)
